(19) United States
(12) Patent Application Publication
(10) Pub. No.: US 2016/0162924 A1
(43) Pub. Date: Jun. 9, 2016

(54) Track user activities and in exchange provide points to use for various activities including advertising contents to targeted users of network

(71) Applicant: Yogesh Rathod, Mumbai (IN)

(72) Inventor: Yogesh Rathod, Mumbai (IN)

(21) Appl. No.: 15/017,592

(22) Filed: Feb. 6, 2016

Related U.S. Application Data
(63) Continuation of application No. PCT/IB2015/059169, filed on Nov. 27, 2015.

(51) Int. Cl. G06Q 30/02; G06Q 50/00

(52) U.S. Cl. CPC G06Q 30/0217; G06Q 30/0231; G06Q 30/0263; G06Q 50/01

(57) ABSTRACT

Various embodiments of a system, methods, platform, database, search engine & device for monitor, track & store user(s) or group of users activities, actions, interactions, events, transactions, status, senses, locations, places, behavior and based on that provide points which user can redeem, use, share, buy, sell, store, transfer, gift, assign, value, unitize, use for payment, use as medium of exchange & spend or spend only for particular purpose said points including use points for broadcasting, sharing, presenting & advertising user content to other target users of network. In another embodiment virally grow user base or customer base by using user's opt-in contacts.

This is a continuation of International Application PCT/IB2015/059169, with an international filing date of 27 Nov. 2015, having title: Track user activities and in exchange provide points to use for various activities including advertising contents to targeted users of network.

### COPYRIGHTS INFORMATION

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever. The applicant acknowledges the respective rights of various Intellectual property owners.

### FIELD OF INVENTION

The present invention relates generally to user to user content broadcasting, sharing, viewing, posting, advertising and presenting platform and virally grow user base by using user's opt-in contacts information. In another embodiment present invention also relates to social currency wherein central unit monitors user activities and based on that assign or provide or add points to user and in exchange of said points user can use for other various purposes.

### BACKGROUND OF THE INVENTION

Currently Google provides search engine to user, so user can search contents. Along with search result Google search engine shows contextual advertisement(s) based on matchmaking of searching keyword(s) and advertisement related keyword(s). Google search engine Adwords charges for presenting of said advertisements to searching or viewing users based on number of views or clicks or impressions or conversions.

Present invention enables user to view preference based or search advertised or broadcasted or shared or presented contents of other users of network and in exchange of that earn particular number of points wherein said earned or balance points, user can utilize or redeem for broadcasting or sharing or presenting or advertising his/her contents to particular number of preference based target viewers. So user will not charge actual money for advertising or viewing by users of network or take actions by other users of network. For earning points, user has to view other users' contents.

Present invention also enables monitoring & tracking of user activities, actions, interactions, events, transactions, status, senses, locations, places, behavior; storing user activities, actions, interactions, events, transactions, status, senses, locations, places, behavior and associate data, metadata & system data and based on said each user's activities, actions, interactions, events, transactions, status, sense, locations, places & behavior store or add pre-defined points or dynamically provide points or number of numeric values to user; and enable user to redeem, use, store, transfer, assign, value, unitize, use for payment, use as medium of exchange, sell & spend or spend only for particular purpose said points or number of numeric values or number of points related to particular type of point(s) or set or group(s) of points.

Therefore, it is with respect to these considerations and others that the present invention has been made.

### OBJECT OF THE INVENTION

The principal object of the present invention is to enabling user to view shared or broadcasted or posted or advertised contents of other users of network and in exchange of this user earns particular number of viewers based on types, numbers & duration of content views and taking actions on content or associate with contents. User can spend or redeem or use said earned points or views for broadcasting or advertising or posting of user's own one or more type(s) of contents or media including text, photo, video, image & voice and any combination thereof to target viewers.

The other object of the present invention is to ask opt-in permission to user to retrieve user's contacts including phone contacts, email address, various user names related to social networking web sites or applications and utilize said contacts of said user to invite them for one or more purposes including install application(s).

Other important object of present invention is to ask user to provide opt-in permission to utilize user's selective profile & device data including contact information for advertising, marketing, sending or presenting contents or customized contents to their contacts. For example ask user to provide their phone contacts for sending their contacts, SMS comprising advertisement content, conveying user's contact(s) to download, install & register particular application which said user also downloaded.

Other important object of present invention is to monitoring & tracking user's activities, actions, interactions, events, transactions, status, senses, locations, places, behavior; storing user's activities, actions, interactions, events, transactions, status, senses, locations, places, behavior and associate data, metadata & system data and based on said each user's activity, action, interaction, event, transaction, status, sense, location, place & behavior store or add pre-defined points or dynamically provide points or number of numeric values to user; and enable to redeem, use, store, transfer, assign, value, unitize, use for payment, use as medium of exchange, sell & spend or spend only for particular purpose said points or number of numeric values or number of points related to particular type of point(s) or set or group(s) of points.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” posted or shared contents & communication and any types of multimedia contents from a device or component includes receiving the shared or posted contents & communication and any types of multimedia contents indirectly, such as when forwarded by one or more other devices or components. Similarly, “sending” shared contents & communication and any types of multimedia contents to a device or component includes sending the shared contents & communication and any types of multimedia contents indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Embodiments described herein enabling user(s) or group(s) of users to take one or more actions, activities, interactions, senses & transactions on/with presented or shared one or more types of one or more media contents of/from one or more users or sources. Based on said monitoring & tracking of said user actions, activities, interactions, senses & transactions, determine and store values or number of points and enabling user to post or present or share or broadcast or start campaign of advertising or advertise one or more types of one or more media contents as per one or more target preferences & rules to contextual viewers or number of contextual viewers or preference based viewers or users of network based on said earned or stored points.

In an embodiment said actions, activities, interactions, senses & transactions comprises view, read, listen, click & tap, conversion, impression, calls, visit web site, download application, purchase product, fill forms or survey, ask queries, like, dislike, provide feedback, ratings & reviews or comments, indicate interest to buy, visiting to shop, already purchased or using.

In an embodiment media contents includes text, link, photo, video, voice, controls (combo box, list, button, menu, radio button, check box), application, web service, object, function, web site, web page, document or file, slide show, one or more type of digital content(s) or resource(s), job profile, article or news or blog, advertisement, edited user photo or video, associate metadata including one or more categories, keywords, date & time of posting, location, type of device, user's unique identity, user data, preferences, privacy settings, presentation settings & any combination thereof.

In an embodiment present one or more media contents to user based on preferences & rules including on one or more search keyword or phrases, match-making preferences, selected or subscribed one or more categories, keywords, locations, entity type, type of content, type of source or user, user contacts or groups or names and user data including profile, location, status, activities, actions, triggering of events, transactions & senses and date & time, any type of content, filter applied by user at the time of viewing to view and any combination thereof.

In an embodiment enabling user to post or present or share or broadcast or advertise one or more types of one or more media contents as per one or more target preferences & rules comprising selected one or more categories, keywords, locations, type of content, type of users or destinations, type of presentation, user contacts or groups or names and user data including profile, age, gender, interest, group & network type, globally or auto present as per default settings or preferences, location(s), place(s), status, activities, actions, events, transactions & senses of sending or receiving user and date & time, balance number of points and any combination thereof.

In an embodiment store values or number of points based on one or more rules including predetermined values or number of points different for one or more types of predetermined one or more or predetermined number of actions, activities, interactions, senses & transactions including view, read, listen, click, like, dislike & tap, duration, location, user profile, type of content, duration spent on content.

In an embodiment determine providing, adding or storing values or number of points based on number of actions, activities, interactions, senses & transactions, number of actions, activities, interactions, senses & transactions within particular duration or date & time ranges, number of actions, activities, interactions, senses & transactions at one or more location(s) or place(s), duration of time spent, location of posting, type of content, language of content, re-share or refer to number of users or contacts and any combination thereof.

In an embodiment queuing and presenting said posted contents to current active users based on total number of balance views of said each posted contents of all users of network and total current active users or viewers in network, date & time of posting, date & time of viewing user or current active user, wherein based on that reduce or increase number of points required for per target viewer and in the event of more viewers enabling 3^{rd} parties to present advertisements or contents and in the event of less viewers queuing and removing contents based on various factors including remove as per first posted first remove basis, wherein balance views based on earned balance points.

In an embodiment add predetermined number of points for one or more predetermined user actions, activities, interactions, senses & transactions on one or more types of contents and deduct point in the event of number of dislikes and report as spam or inappropriate content.

In an embodiment validate total number of available balance points before posting of content as per user selected one or more preferences, criteria, target viewer preferences & rules & notify user, wherein in the event of less amount of balance point instruct user to reduce target viewers.

In an embodiment enabling user to spent more points per view for better results including more actions or downloads or purchases, share, transfer, gift, redeem points in exchange of money, product, application, service, coupon, offer & like, assign, buy and sale points to one or more users of network.

In an embodiment enabling user to create campaigns for broadcasting or advertising contents, apply bid in terms of number of points for one or more content, type of content, type of target action(s) or for one or more target preferences, update target viewers of posted content(s) or campaign(s) related preferences, start or pause or stop as per schedule, start, pause & stop or remove, and adjust or fine-tuning one or more posting or presenting of contents or advertisement campaign(s) to targeted viewer(s).

In an embodiment enabling user to search & match posted or shared or advertised contents as per one or more keywords, preferences, criteria, Boolean operators, categories, filters, sort, number of result per page and any combination thereof.

In an embodiment present analytics, insight, logs, reporting, statistics to user regarding posted or viewed contents or campaigns.

In an important embodiment enabling user to provide permission to use or access user's one or more contacts for one or more types of purposes; apply one or more rules for retrieving, processing and filtering contacts locally or at user device; storing said contacts and contacts information at central unit apply one or more rules for processing and filtering contacts at central unit or server; store preferences, parameters, settings and content(s) or content template(s); allow to prepare or auto generate customized content(s) for each contact or group(s) of contact(s) of each user(s); and send, distribute, broadcast, share & present said content(s) to said user's retried or fetched contact(s) via one or more channels.

In an embodiment one or more channels including SMS, Email, IM, Web site, Phone call, and VOIP Call.

In an embodiment present invention also enables monitoring & tracking user(s) or group of users pre-defined & pre-identified or pre-specifies or pre-determined activities, actions, interactions, events, transactions, status, senses, locations, places, behavior from one or more domains, web sites, applications, objects, controls, interfaces, services, servers, devices, networks, databases, & sources, storing said user or group of users or linked users or categories of users' activities, actions, interactions, events, transactions, status, senses, locations, places, behavior and associate data, metadata & system data and based on said each user or group of users or linked users or categories of users' each activity, action, interaction, event, transaction, status, sense, location, place & behavior store or add pre-defined points or dynamically provide points or number of numeric values to user and enable to redeem, use, store, transfer, assign, value, unitize, use for payment, use as medium of exchange, buy, sell & spend or spend only for particular purpose said points or number of numeric values or number of points related to particular type of point(s) or set or group(s) of points.

Wherein said activities, actions, interactions, events, tasks, transactions, status, senses, locations, places, behavior comprises view other users' contents and take one or more actions on it, provide user services to other users of network, download particular mobile applications, register web site(s), buy products & services, spent money or conduct transactions, visit particular place, view video, click or tap particular content item or controls, listen music, search at particular web site, refer customer, re-share within friends or contacts, like or dislike, participate in particular group, view advertising.

In an embodiment provide different number of points to different users for conducting or participating or taking one or more pre-defined activities, actions, interactions, events, transactions & senses and have particular status, locations & places and any combination thereof.

In an embodiment monitoring, tracking & storing user or group of users activities, actions, interactions, events, transactions, status, senses, locations, places, behavior including enabling user to take one or more actions, activities, interactions, senses & transactions on/with presented or shared one or more types of one or more media contents of/from one or more users or sources; based on said each user's one or more activities, actions, interactions, events, transactions, status, senses, locations, places, behavior and any combination thereof determine and store or add pre-defined points or provide purpose specific points or dynamically provide points or number of numeric values to user; and enable to redeem, use, share, buy, sell, store, transfer, gift, assign, value, unitize, use for payment, use as medium of exchange, sell & spend or spend only for particular purpose said points or number of numeric values or number of points related to particular type of point(s) or set or group(s) of points including enabling user to post or present or share or broadcast or start campaign of advertising or advertise one or more types of one or more media contents as per one or more target preferences & rules to number of contextual viewers or preference based viewers based on said earned or stored points or use points for buying products, services, tickets, get coupons, get one or more types of user service from one or more users from one or more networks or sources and make payment for particular task(s) or use points in exchange of money, application, offer & like.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates an example system for enabling a user to post contents and view contents of other users of network using a computing device, under an embodiment.

FIG. 2 illustrates some examples, according to various embodiment of present system.

FIG. 3 illustrates user broadcasted, advertised & shared contents search engine for enabling other users or users of network or searching user or prospective customers to search local shops, service providers, products, businesses, entities & like and in exchange of viewing search result item(s) user gain points which will user can redeem or spent in advertising user contents to targeted users of network;

FIG. 4 illustrate graphical user interface, wherein user can subscribe one or more categories and keywords to follow said subscribed categories or keyword specific broadcasted, advertised & shared contents and/or sources of contents for receiving updated broadcasted, advertised & shared contents;

FIG. 5 illustrate graphical user interface, wherein user can browse or navigate or access categories directory for searching and viewing or taking one or more associate actions on user broadcasted, advertised & shared contents;

FIG. 6 and FIG. 7 illustrate graphical user interface, wherein user can browse or navigate or access categories tab specific contents and can view or take one or more associate actions on user broadcasted, advertised & shared contents;

FIG. 8 illustrate graphical user interface for enabling user to draft, update and manage broadcasted, advertised & shared contents and campaigns including set target preferences & settings;

FIG. 9 illustrate graphical user interface for enabling user to set broadcasted, advertised & shared contents target preferences & settings for presenting said content to said target preferences & settings users of network;

FIG. 10 illustrate graphical user interface for enabling user to view various statistics and provide notification & other settings;

FIG. 11 illustrate flowchart explaining how central unit retrieve, processes, filter & utilize user's opt-in contacts from user device as per user permission, according to an embodiment;

FIG. 12 illustrate examples of flowchart describe in FIG. 3, according to an embodiment;

FIG. 13 is a block diagram that illustrates a mobile computing device upon which embodiments described herein may be implemented.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

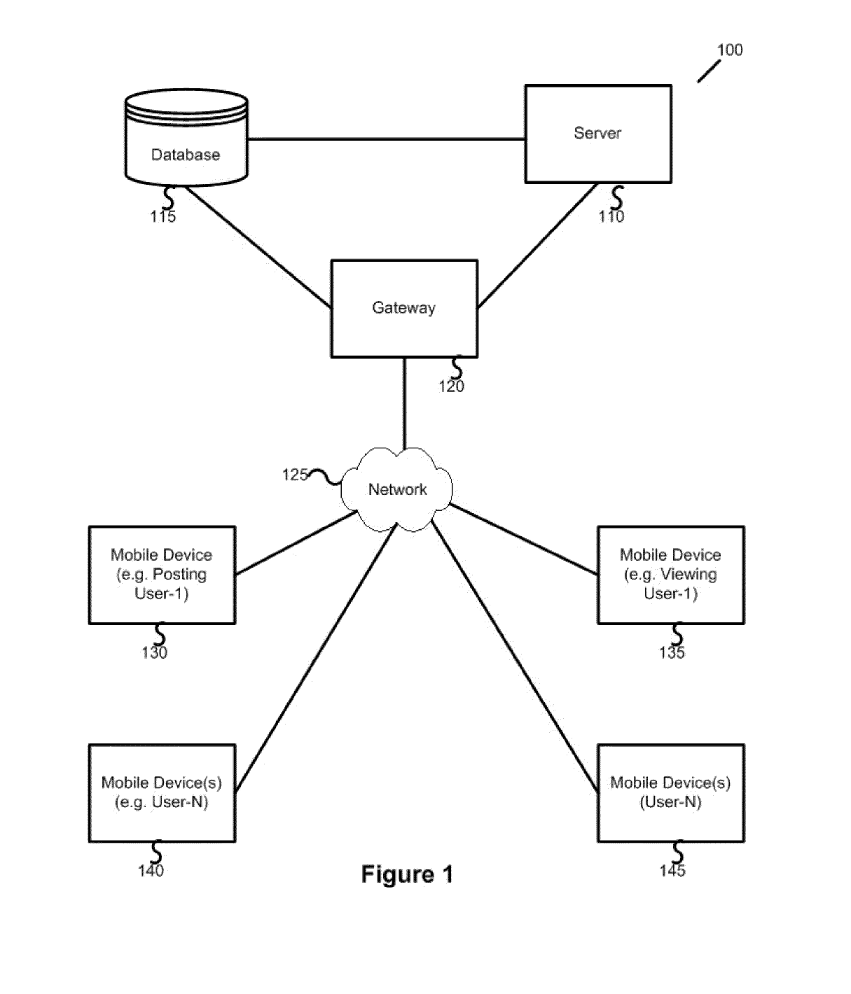

FIG. 1 illustrates an example user to user content advertising platform, under an embodiment. According to some embodiments, system 100 can be implemented through software that operates on a portable computing device, such as a mobile computing device 110. System 100 can be configured to communicate with one or more network services, databases, objects that coordinate, orchestrate or otherwise provide advertised contents of each user to other users of network. Additionally, the mobile computing device can integrate third-party services which enable further functionality through system 100.

The system for enabling users to use platform for broadcasting or sharing or posting or presenting or advertising user contents to other contextual users or target viewers of network based on one or more preferences and viewing searched or subscribed contents as per selection & preferences or contextual contents of other users of network. While FIG. 1 illustrates a gateway 120, a database 115 and a server 110 as separate entities, the illustration is provided for example purposes only and is not meant to limit the configuration of the user to user advertising & viewing user contents based system. In some embodiments, gateway 120, database 115 and server 110 may be implemented in the user to user advertising & viewing user contents based system as separate systems, a single system, or any combination of systems.

As illustrated in FIG. 1, the user to user advertising & viewing users' contents based system may include a posting user device or mobile devices 130/140 and viewing user device or mobile devices 135/145. Devices or Mobile devices 130/140/135/145 may be particular set number of or an arbitrary number of devices or mobile devices which may be capable of posting, sharing, publishing, broadcasting, advertising, sending, presenting, searching, matching, accessing and managing shared contents to target contextual viewers or users of network who search or follow particular or one or more or group(s) or set of categories, keywords, key phrases, named entities, nodes, ontology, and taxonomies. Each device or mobile device in the set of posting user(s) 130/140 and viewing user(s) device or mobile devices 135/140 may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the user to user content advertising system may include gateway 120. Gateway 120 may be a web gateway which may be configured to communicate with other entities of the user to user content advertising system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of user to user content advertising system. In various embodiments, gateway 120 may be connected to database 115 and/or server 110 via a wired or a wireless network connection.

Gateway 120 may be configured to send and receive user contents or posts or data to targeted or prospective, matched & contextual viewers based on preferences, wherein user data comprises user profile, user connections, connected users' data, user shared data or contents, user logs, activities, actions, events, senses, transactions, status, updates, presence information, locations, check-in places and like) to/from mobile devices 130/140/135/145. For example, gateway 120 may be configured to receive posted contents provided by posting users or publishers or content providers to database 115 for storage.

As another example, gateway 120 may be configured to send or present posted contents to contextual viewers stored in database 115 to mobile devices 130/140/135/145. Gateway 120 may be configured to receive search requests from mobile devices 130/140/135/145 for searching and presenting posted contents.

For example, gateway 120 may receive a request from a mobile device and may query database 115 with the request for searching and matching request specific matched posted contents, sources, followers, following users and viewers. Gateway 120 may be configured to inform server 110 of updated data. For example, gateway 120 may be configured to notify server 110 when a new post has been received from a mobile device or device of posting or publishing or content broadcaster(s) or provider(s) stored on database 115.

As illustrated in FIG. 1, the user to user content advertising system may include a database, such as database 115. Database 115 may be connected to gateway 120 and server 110 via wired and/or wireless connections. Database 115 may be configured to store a database of registered user's profile, accounts, posted or shared contents, followed updated keyword(s), key phrase(s), named entities, nodes, ontology, semantic syntax, categories & taxonomies, user data, payments information received from mobile devices 130/140/135/145 via network 125 and gateway 120.

Database 115 may also be configured to receive and service requests from gateway 120. For example, database 115 may receive, via gateway 120, a request from a mobile device and may service the request by providing, to gateway 120, user profile, user data, posted or shared contents, user followers, following users, viewers, contacts or connections, user or provider account's related data which meet the criteria specified in the request. Database 115 may be configured to communicate with server 110.

As illustrated in FIG. 1, the user to user content advertising system may include a server, such as server 110. Server may be connected to database 115 and gateway 120 via wired and/or wireless connections. As described above, server 110 may be notified, by gateway 120, of new or updated user profile, user data, user posted or shared contents, user followed updated keyword(s), key phrase(s), named entities, nodes, ontology, semantic syntax, categories & taxonomies & various types of status stored in database 115.

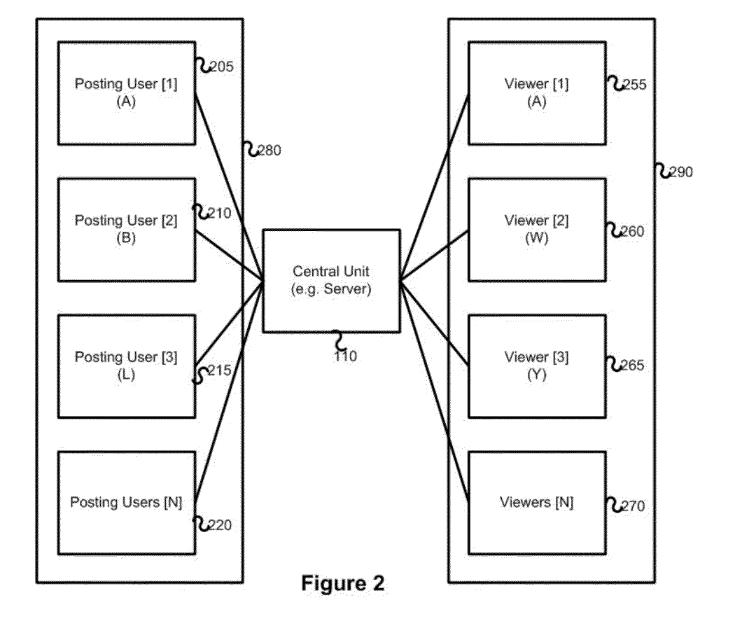

In another embodiment the system for presenting & broadcasting users generated contents to contextual viewers based on user preferences & user data (discussed in detail in FIG. 2) may be referred to herein, for simplicity, as the “broadcasting or advertising user contents to contextual viewers based system or user to user content advertising system.” FIG. 1 illustrates a block diagram of an broadcasting or advertising user contents to contextual viewers based system configured to implement the platform where user(s) can post contents to target viewers and/or search, match, browse, filter, view & select one or more search query specific or categories and taxonomies specific posted contents of other users of network. While FIG. 1 illustrates a gateway 120, a database 115 and a server 110 as separate entities, the illustration is provided for example purposes only and is not meant to limit the configuration of the broadcasting or advertising user contents to contextual viewers based system. In some embodiments, gateway 120, database 115 and server 110 may be implemented in the posting user contents and broadcasting or advertising user contents to contextual viewers based system as separate systems, a single system, or any combination of systems.

As illustrated in FIG. 1, the broadcasting or advertising user contents to contextual viewers based system may include a posting user device or mobile devices 130/140 and viewing user device or mobile devices 135/145. Devices or Mobile devices 130/140/135/145 may be particular set number of or an arbitrary number of devices or mobile devices which may be capable of posting, sharing, publishing, broadcasting, advertising, sending, presenting, searching, accessing and managing shared contents to target contextual viewers or users of network. Each device or mobile device in the set of posting user(s) 130/140 and viewing user(s) device or mobile devices 135/140 may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the broadcasting or advertising user contents to contextual viewers based system may include gateway 120. Gateway 120 may be a web gateway which may be configured to communicate with other entities of the broadcasting user contents to contextual viewers based system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of the broadcasting or advertising user contents to contextual viewers based system. In various embodiments, gateway 120 may be connected to database 115 and/or server 110 via a wired or a wireless network connection.

Gateway 120 may be configured to send and receive user posted contents or posts or data to prospective, matched & contextual viewers based on preferences and matched user data of users, wherein user data comprises user profile, user connections, connected users' data, user shared data or contents, user logs, activities, actions, events, senses, transactions, status, updates, presence information, locations, check-in places and like to/from mobile devices 130/140/135/145. For example, gateway 120 may be configured to receive posted contents provided by posting users or publishers or content broadcasters to database 115 for storage.

As another example, gateway 120 may be configured to send or present posted contents to followers of categories & taxonomies or contextual viewers stored in database 115 to mobile devices 130/140/135/145. Gateway 120 may be configured to receive search requests from mobile devices 130/140/135/145 for searching and presenting posted contents.

For example, gateway 120 may receive a request from a mobile device and may query database 115 with the request for searching and matching request specific matched posted contents, sources, followers, following users and viewers who are located at request specific place(s) or location(s). Gateway 120 may be configured to inform server 110 of updated data. For example, gateway 120 may be configured to notify server 110 when a new posts has been received from a mobile device or device of posting or publishing or content broadcaster(s) provider(s) stored on database 115.

As illustrated in FIG. 1, the broadcasting or advertising user contents to contextual viewers based system may include a database, such as database 115. Database 115 may be connected to gateway 120 and server 110 via wired and/or wireless connections. Database 115 may be configured to store a database of registered user's profile, accounts, posted or shared contents, followed updated categories & taxonomies, user data, payments information received from mobile devices 130/140/135/145 via network 125 and gateway 120.

Database 115 may also be configured to receive and service requests from gateway 120. For example, database 115 may receive, via gateway 120, a request from a mobile device and may service the request by providing, to gateway 120, user profile, user data, posted or shared contents, user or provider account's related data which meet the criteria specified in the request. Database 115 may be configured to communicate with server 110.

As illustrated in FIG. 1, the broadcasting user contents to contextual viewers based system may include a server, such as server 110. Server may be connected to database 115 and gateway 120 via wired and/or wireless connections. As described above, server 110 may be notified, by gateway 120, of new or updated user profile, user data, user posted or shared contents, user followed updated categories & taxonomies & various types of status stored in database 115.

FIG. 2 illustrates various examples of user to user content advertising & viewing system. For example viewing user [A] 255 take one or more actions, activities, interactions, senses & transactions on/with presented or shared one or more types of one or more media contents of one or more users or sources of network 280. Based on monitoring & tracking of said user's [A's] 255 actions, activities, interactions, senses & transactions, central unit or super node or server 110 determines and stores values or number of points. After accumulating particular number of points posting user [A] 205 is now able to post or present or share or broadcast or start advertising campaign or advertise one or more types of one or more media contents as per one or more target preferences & rules to contextual number of viewers or users of network 290 based on said earned or stored points via central unit or server 110. Postings user 205 can draft advertisement or capture or record or select photo or video or voice or draft text and select various preferences & settings to select target viewers for said posted advertisement or content including locations, places, gender, age ranges, languages, interests, networks, entities & like that's well known in targeting advertisements. Posted contents, associate metadata with user's advertisement target preferences stored at central unit or server 110. Central unit or server 110 matches the posting user's 205 advertisement target preferences with data of users of network 290 including profile data, preferences, and search query and present posting user's 205 advertisement or content to contextual users of network 290 e.g. user 255 and user 265, wherein user 255 and user 265 can view said posted advertisement or content of posting user 205.

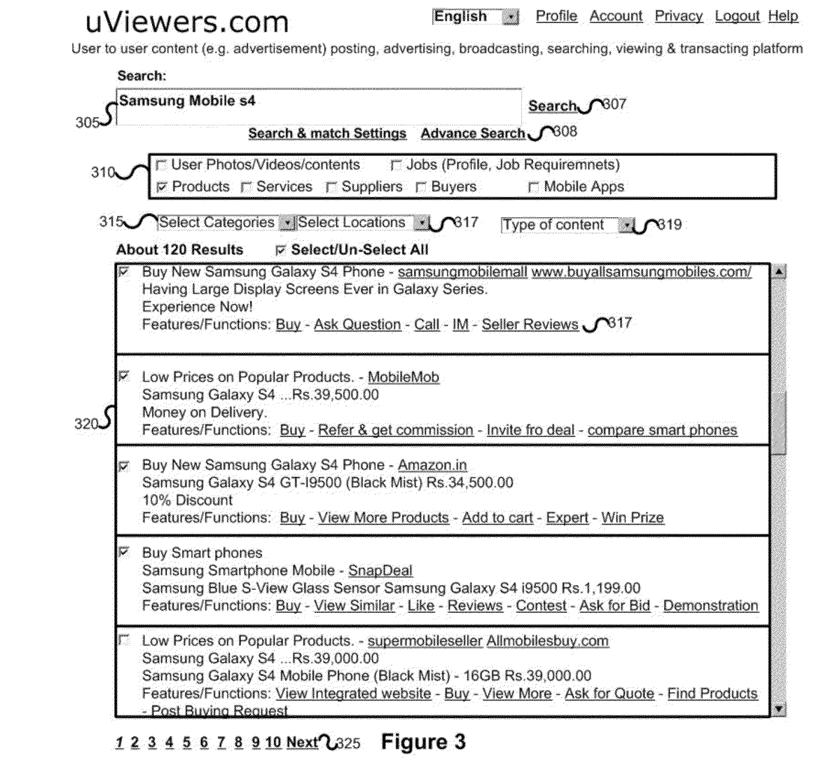

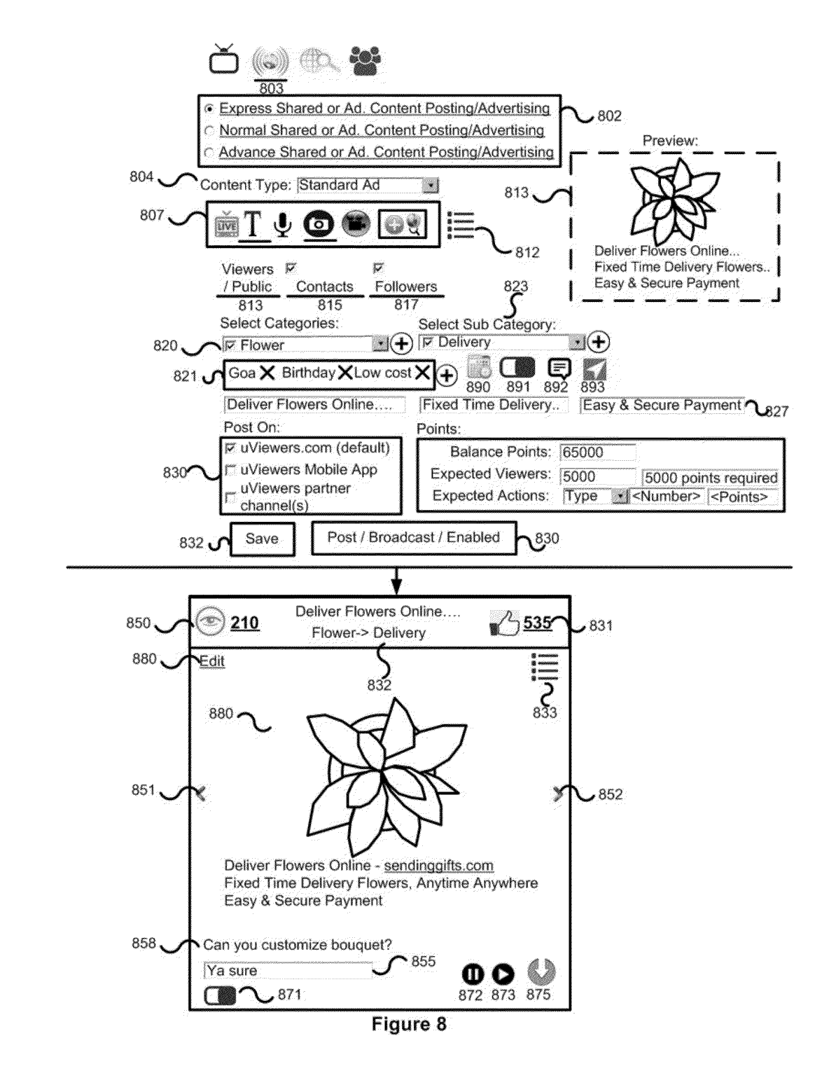

FIG. 3 illustrates that user can search advertised or shared or broadcasted contents of other users of network, wherein said posted or advertised or shared content by user base on target preferences set by said posting or advertising or broadcaster user including include or exclude location & IP addresses, language, categories, keywords, show content based on one view or one action in exchange of one point based model or set bid number of points for per view and/or per action i.e. pay or spent point for per view/each action model (discuss in detail in FIGS. 8 & 9). User can input or select or select from auto fill list of search keywords or search query 305 and click or tap on “search” button 307 for viewing 320 said search keywords or search query or search phrases specific advertised or shared or broadcasted one or more types of contents of other users of network. In an another embodiment user is presented with abstract of each search result item specific content, so user can tap on preferred or select particular search result item and view associate contents completely. So user's actual number of views of or clicks on search result items or contents can monitored and tracked to determine number of contents or advertisements or search result items user viewed and accordingly add points, wherein adding of points is based on plurality of factors including type of content user viewed or tapped or clicked or listen or read or took one or more actions from list of action presented with search result item, number or type of actions user taken, number & amount of transaction, date & time, location, place, language, age & gender of user, contextual user based on advertisement criteria. It's possible all user gets fix amount of point or variable amount of points in spite of viewing same content or search result item or advertised content. User can select on or more categories 315 to filter 310 or location 317 or search category 315 or location 317 specific advertised or shared or broadcasted one or more types of contents of other users of network. In one embodiment present or rank search result as per maximum bids in terms of number of points, maximum number of points pending to spent for particular advertisement or shared or broadcasted content, location of user and any combination thereof. User can also search or filter as per type of content including photo, image, video, live stream, text, voice, application, one or more types of forms related posted or advertised or broadcasted contents including user profile, job profile, blog & like, and any combination thereof. User can add to cart, order, book, make payment, ask query to seller or chat with seller for details or answers or negotiation, bookmark, add to buying list or wish list, share, refer, like, dislike, rate & provide comments for/on one or more search result items and subscribe source for receiving new or updated contents from selected search result item associate source(s). In an another embodiment auto present broadcasted or shared or advertised contents of other users of network to each user based on user activities, actions, interactions, events, transactions, logged data, user data, profile data, current or selected or logged location(s), place(s), senses, behavior, status, date & time, device type, data network type, balance number of points. User can use advance search option to search more specific and contextual posted or shared or broadcasted contents by users of network including one or more locations or place specific, posting date & time or date & time range specific, one or more types of contents, languages & location, posting user's age or age ranges, gender, interest, entity name or type including company, school, college & shop, number of likes. In an embodiment remove contents of posting or advertising or broadcasting user(s) from search results after delivery completed or targeted advertising or broadcasting content campaign is paused or stopped or cancelled as per campaign presences & settings including scheduled date & time, number of points, number of targeted views & actions & like (discuss in detail in FIGS. 8 & 9).

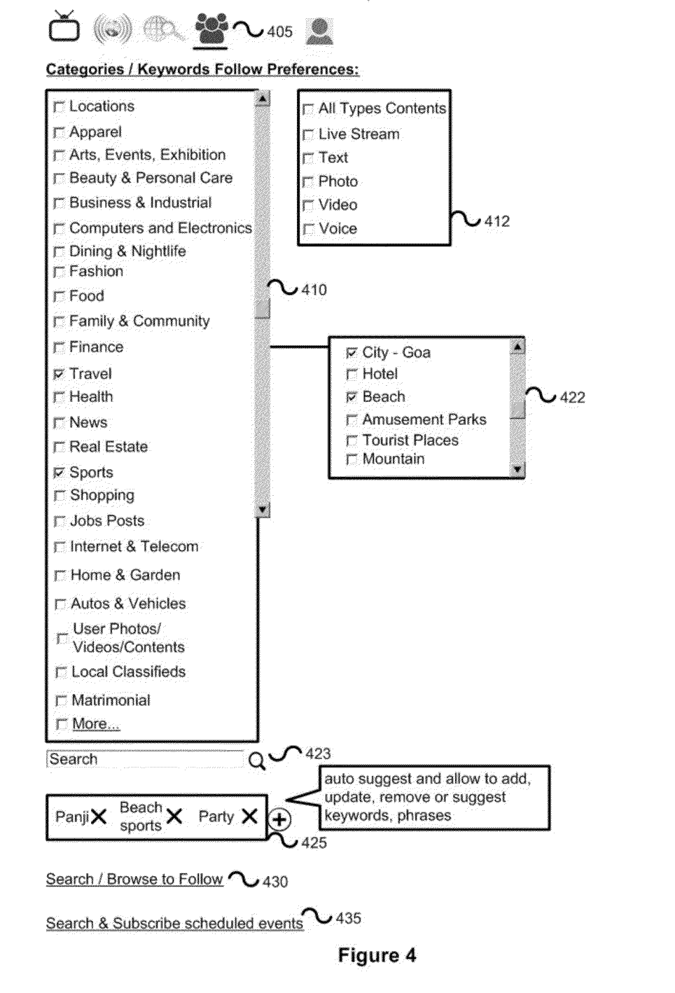

FIG. 4 illustrates that user can search 423, match select, add, remove, suggest one or more categories or taxonomy or ontology 410, sub-categories 422 & keywords or phrases 425 to subscribe said selected one or more categories, sub-categories & keywords specific advertised, broadcasted or shared contextual contents of users of network. User can search, match, browse & select one or more sources or users of network of advertised, broadcasted or shared contents to follow or subscribe them 430. User can also subscribe contents posted or broadcasted or advertised at particular date & time or related to particular event, activity, brand, entity, conference, location, and place 435.

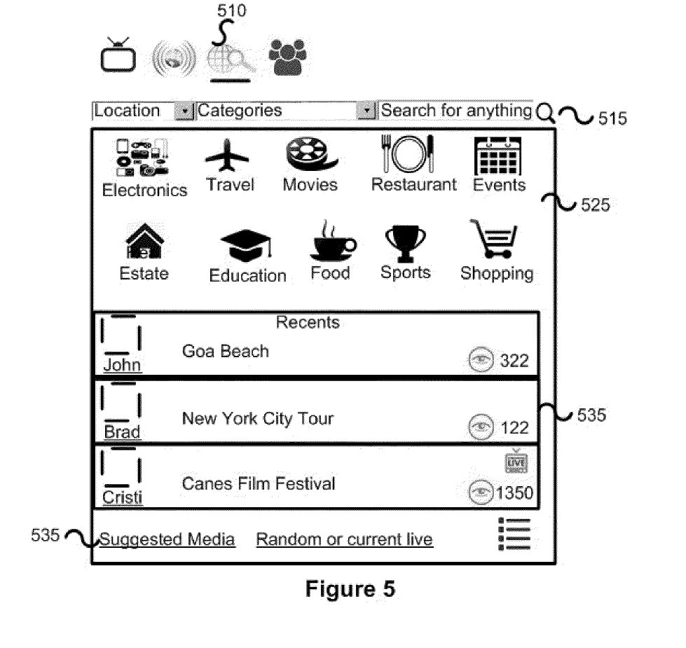

FIG. 5 illustrates that user can use categories directory 525 for searching, matching, selecting, navigating, accessing, viewing, conducting one or more actions on one or more directory listing or search result item(s) or searched content items or broadcasted, advertised & shared contents of users of network. User can select, click, tap, view & take one or more actions on recently posted 535 broadcasted, advertised & shared contents of users of network. User can view suggested broadcasted, advertised & shared contents of users of network based on user data & profile, user activities, actions, events, senses, transactions, locations, date & time, places & status. In an embodiment user can view live stream related to one or more categories, keywords, location place, activity, entity, type of entity, channel, brand, & event specific broadcasted, advertised & shared contents of users of network.

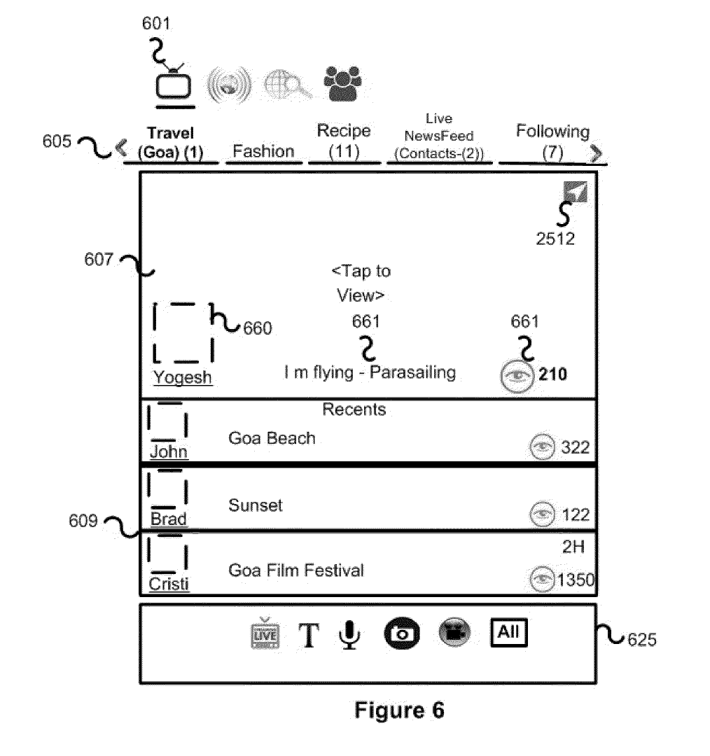

FIG. 6 illustrates that user can view, listen, read, access & take one or more content item associate actions on subscribed or searched or selective categories specific auto presented or manually selected posted or broadcasted or advertised contents of users of network.

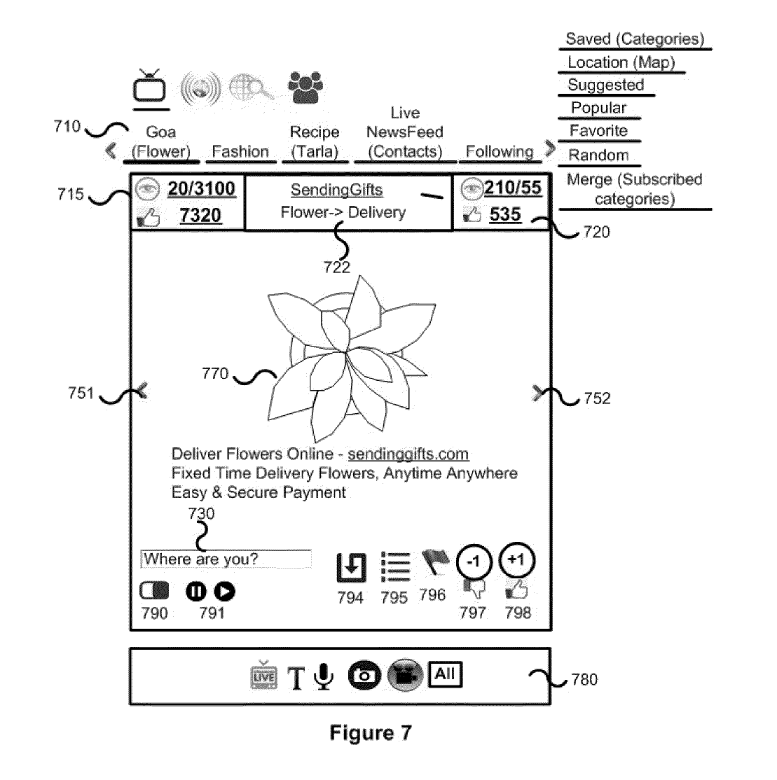

In an important embodiment FIG. 7 illustrates that user is automatically presented with broadcasted or advertised or shared or published or posted consents of users of network based on user activities, actions, interactions, events, transactions, logged data, user data, profile data, current or selected or logged location(s), place(s), senses, behavior, status, date & time, subscriptions, user preferences & settings, device type, data network type, balance number of points. User can access auto presented contents as per selection of categories or tabs 710. User can view total number of content items, total number of viewers related to selected or current selected tab or category e.g. (Goa-Flower 710) 715 within particular period of time or duration, User can also view number of total points/likes of all viewers related to selected or current tab or category (Goa-Flower 710) 720 within particular period of time or duration, number of viewers, number of Live Viewers, Points/Likes, Time watched, Duration, Retention (local save). User can view auto presented or selected items and latest content items. In an embodiment user is dynamically presented with next and previous button or present next and previous button in different position after each time next or previous, so user can view previous 751 or view next 752 content item within particular period of time or duration with open eye or guarantee to view content item. User can filter one or more type of content 780 to view contents. User can show or hide 790 chat or one or more type(s) of applications or interfaces or set of controls on content item(s). In an embodiment user can pause or re-start or play 791 content. In an embodiment user can save content item e.g. 770 locally 794, bookmark source, viewing user can tag content item(s), search, match, select, access & view list of content items related to selected tab or category 710 i.e. list 794, report content as spam, copyrighted or other's content, non-contextual, not good quality & inappropriate 796, user can give one or more likes 798 or dislike(s) 797. In an embodiment auto present next content item base on various rules for different types of content items including if photo content item then after 1 or 2 or particular seconds move to next content item, if video or live streaming or voice content item then move next when video finish or length of duration video, if content item is text then based on number of characters or words or lines move next.

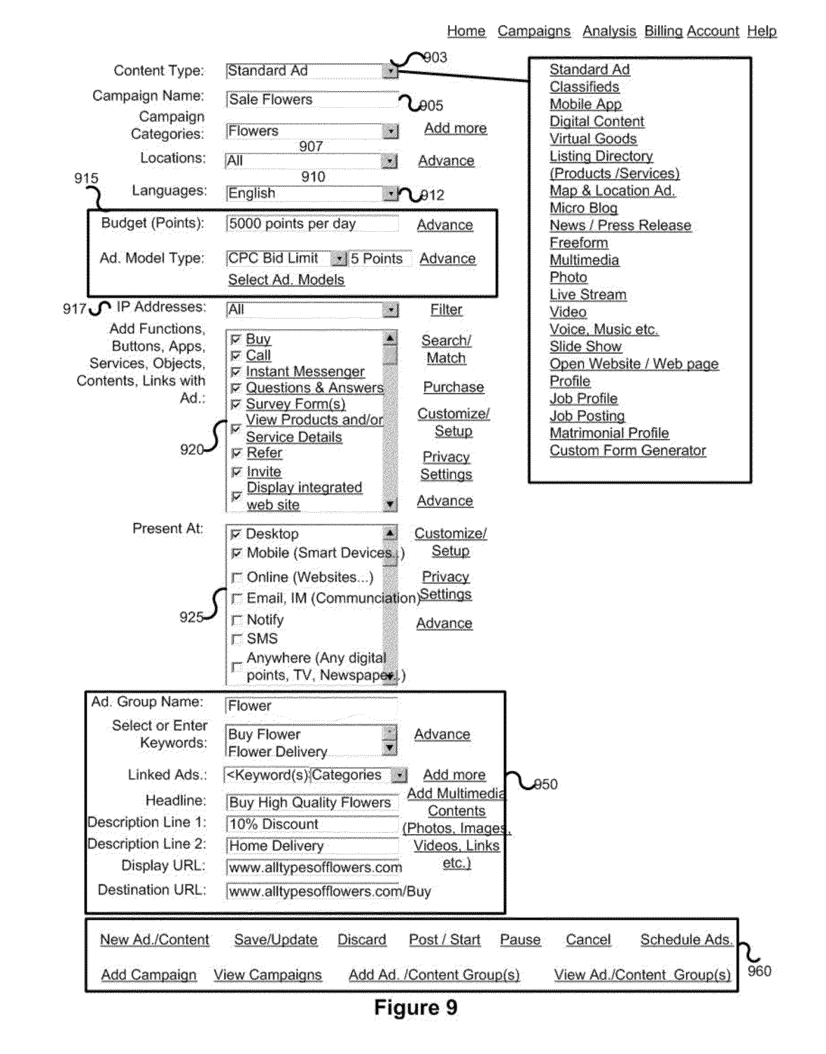

FIG. 8 illustrates exemplary user interface for advertising, broadcasting & sharing of one or more types of contents to contextual, targeted and preferences based prospective viewers or users of network. User can select type of broadcasting, sharing, advertising, publishing & posting campaign including express sharing or advertising contents 802 where user can select type of content, category, keyword(s) and required minimum settings or popular settings and target viewers or users of network who receives said posted or advertised contents are auto matched for presenting or delivering user's posted or advertised contents, normal sharing or advertising contents where user is presented with minimum required target preferences and settings including location, age ranges, gender, entity type(s) & entity name(s), advance sharing or advertising contents campaign (discuss in detail in FIG. 9) provide all preferences, settings, & filter to contextually target said advertised or shared contents to contextual users or viewers of network including include or exclude or select locations, places, languages, IP addresses, provide budget (number of points) for each view or action or duration (per second view) or other ad. model(s) including select pay predetermined fix points for per view or per second view or per defined action, create ad. or content group(s) and one or more associate ad. content or shared content, select contextual keywords, search, match, download, install, purchase, customize & select one or more user actions, applications, features, functions, controls (link, list box, combo box, checkbox, radio button, function or action button(s) etc.), website, web page & objects, enable or pause stop or cancel or restart campaign(s) or ad group(s) or ad(s). User can select one or more type of contents 804 or 807 & any combination thereof including Standard Ad, Classifieds, Mobile App, Digital Content, Virtual Goods, Listing Directory (Products/Services), Map & Location Ad., Micro Blog, News/Press Release, Freeform, Multimedia, Photo, Live Stream, Video, Voice, Music etc., Slide Show, Open Website/Web page, Profile, Job Profile, Job Posting, Matrimonial Profile, Custom Form Generator & one or more type of digital contents for drafting, editing, saving, updating, selecting, capturing, recording & preparing contents. After selection of content type, user can select broader target group including public or users of network 813, contacts of user 815, followers of users 817 and any combination thereof, select one or more categories 820 and sub-categories 823 and keywords 821. Based on type of content user can select additional details, metadata and preferences. For example when user selects “standard ad.” content type 804 then user is presented with advertisement related title and description 827. User can select one or more target destinations 830 where user want to publish or advertise or present or broadcast or share said drafted or prepared or selected content(s). User can preview 813 the drafted contents.

User can search, browse, add or suggest, input or select or tag 821 one or more contextual keywords related to contents. User can schedule broadcasting or posting of contents 890. User can hide or show user's identity to viewers or show only nick name 891. User can enable or disable or show or hide chat interface or one or more types of other interface or application or set of controls 892 for enabling broadcasting or posting users and viewers to provide comments or share information or take one or more actions on contents including like, dislike, ratings, book, purchase, subscribe, buy. User can also show or hide location and/or current or selective place(s) 893. User can provide title or details of broadcasted to posted contents 827. In an embodiment user can broadcast or post contents to one or more destinations including web sites, web pages, applications, interfaces, devices, servers, databases or storage medium & networks. User can create, update, discard & save 832 one or more campaigns, ad. or content groups, ads or drafted contents, target preferences & settings for later use, updates and broadcasting or advertising or posting purposes. User can post or advertise or broadcast 830 said prepared content(s) to auto matched or settings & preferences based target users or viewers of network.

User can then view real-time statistics related to one or more broadcasted or advertised or shared content(s) 880 to target users of network including number of views 850, number, type & amount activities, actions, interactions, senses, events, transactions 831/833 including likes, dislikes, ratings, report content item as spam or copyright infringements & inappropriate, comments on said broadcasted or advertised or shared contents to target users of network. User can real-time chatting 855 or conversing 858 with one or more viewing users of user's contents. In an embodiment user can edit 880 & update 875 posted contents, associated metadata, categories, keywords, details, target preferences & settings and make available updated content 875 to targeted or viewing users of network. In an embodiment broadcaster or posting user can search, match, make payment, download, install, upload, certify, register, select, customize or configure, attach or post one or more links of objects or applications or user actions or one or more or set of controls including button to access object or web service(s) or interface(s) or form(s) with broadcasted or posted contents or chat e.g. buy button, donate to broadcaster, surveying viewing user(s), order, subscribe, refer, as queries etc. User is enable to on or off current chat 871, pause 872 or re-start 873 serving or delivering of said advertisements or broadcasted or posted sent or shared or published contents to target users of network.

User can select one or more broadcasted or advertised or published or posted content item(s) from list 833 for conduction various tasks including edit, update, remove, pause or restart or stop or cancel delivering or serving of advertised or broadcasted or shared contents, update target preferences & settings, view various statistics and analytics. User can view previous 851 or next 852 advertised or broadcasted or posted or shared or published content item(s). User can also notify about starting or schedule campaign(s), finishing of campaign(s), various status, reach, delivery status, results, analytics & statistics of campaign(s), current number of viewers and actions, number of points spent & like.

FIG. 9 illustrates advance campaign(s) managements, advertisements or contents group(s) related to one or more campaign(s) management, advertisement(s) or content item(s) of one or more advertisements or contents group(s) related to one or more campaign(s) management, targeting preferences & settings. User can select or input or edit one or more content type(s) 903, campaign name 905, one or more campaign categories 907, current or selective or include or exclude one or more locations or places 910, select language(s) 912, select or filter or include or exclude IP addresses 917, daily spending of points budget and model type including pay per view, pay per particular type(s) of viewing user's action(s), pay particular duration of or pay per second viewing of content item(s) & like, select, search, match, purchase, subscribe, upload, download, install & customize one or more user actions or link of user actions including functions, interfaces, objects, applications, services, controls (links, buttons, combo box, list, check box, radio button etc.), forms, web sites, web pages 920, select or customize presentation type(s) and destination(s) 925 for targeting one or more content item(s) or advertisement(s) to said preferences & settings specific users or viewers of network.

User can create, update & remove, view, access, post, start, schedule, pause, stop, restart one or more campaign(s) 960, advertisement groups or content groups 960, advertisement(s) or content item(s) 950 and view associate analytics, statistics & reports.

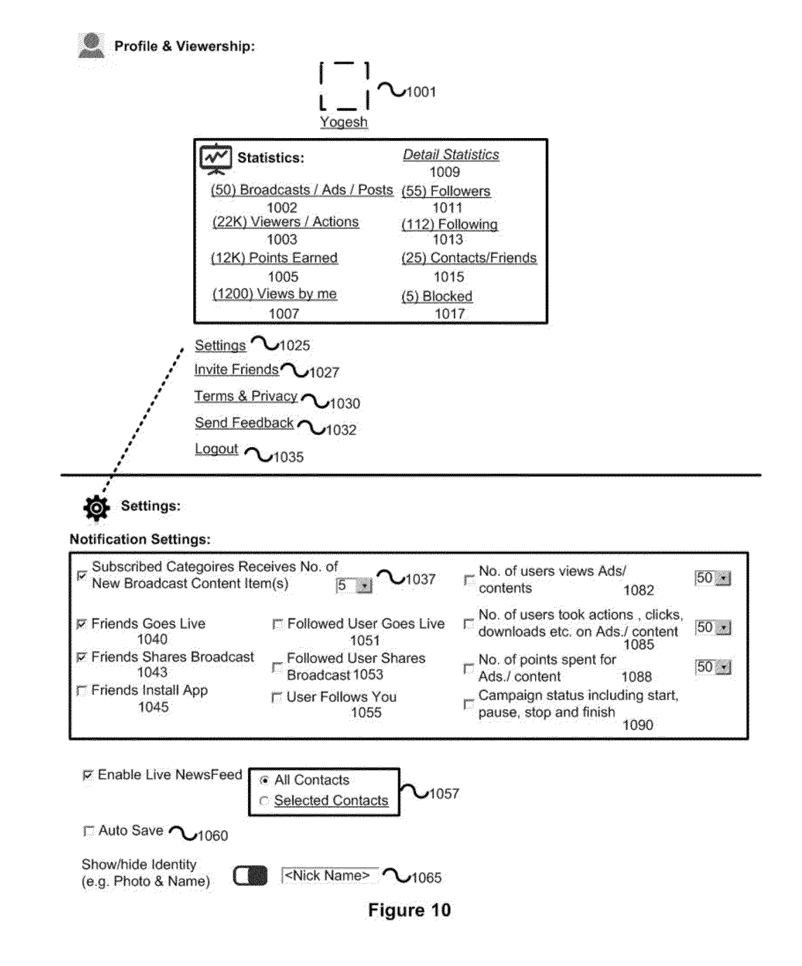

FIG. 10 illustrates exemplary graphical user interface (GUI) for enabling user to view various types of general statistics and apply various settings. User can access, view, update, apply privacy settings to view user's profile by others & share user profile 1001. User can view various statistics including number of broadcasted or advertised or posted content item(s) 1002 which further comprise list of all broadcasted or posted content items details including campaign specific, ad. or content group specific, date & time specific, type of content item specific, number of viewers & actions including likes or dislikes of each content item 1002, number of total viewers 1003 & actions which further includes detail statistics including campaign specific, ad. or content group specific, ad. or content specific, location wise, category wise, keyword wise viewers, duration of views, date & time wise, date & time rang(s) wise viewers 1003, total points eared or total balance points 1005, total number of content items views by user which further comprise list of all viewed & saved content items details including date & time, locally saved content item, type of content item, source name or nick name, related total viewers, views, likes & dislikes, title or description, number of views & likes or dislikes of each content item 1007, statistics including campaign wise, ad. group wise, content item wise, date wise, location wise, category wise, keyword wise, content type wise views & actions. User can also view content item wise detail statics 2809 to find most popular content items, content type(s), content sources, categories, keywords, location of viewers. User can view total number of followers 1011 which further includes name or nick name or profile details of followers. User can view total number of following users 1011 which further includes name or nick name or profile details of following users. User can view list of friends or contacts 1015 including phone book contacts, Facebook friends, contacts related to one or more 3^{rd} parties web sites, applications, web services, social networks & like.

User can access, set, apply, update, input, select one or more types of privacy settings including notification settings comprise receive notification when new content item broadcasted or posted under subscribed categories or keywords 1037 or receive notification only when set particular number of new content items broadcasted or posted under subscribed categories or keywords 1037, receive notification when Friends Goes Live 1040, receive notification when Friends Shares Broadcast 1043, receive notification when Friends Install App 1045, receive notification when Followed User Goes Live 1051, receive notification when Followed User Shares Broadcast 1053 and receive notification when User Follows You 1055. User can enable Live NewsFeed 1057 for all contacts or selected contacts only, so all or selected contacts only can view user's broadcasted or posted content item(s). User can on or off Auto Save 1060 to saving all viewed contents or save each manually from interface. User can show or hide user's Identity (e.g. photo, profile details, status, location, check in or selected place, last seen & name) 1065. User can set settings to notify user when number of users views Ads/contents 1082, number of users took actions on Ads./content 1085, number of points spent for Ads./content 1088 and various campaign status including start, pause, stop and finish of one or more campaign 1090.

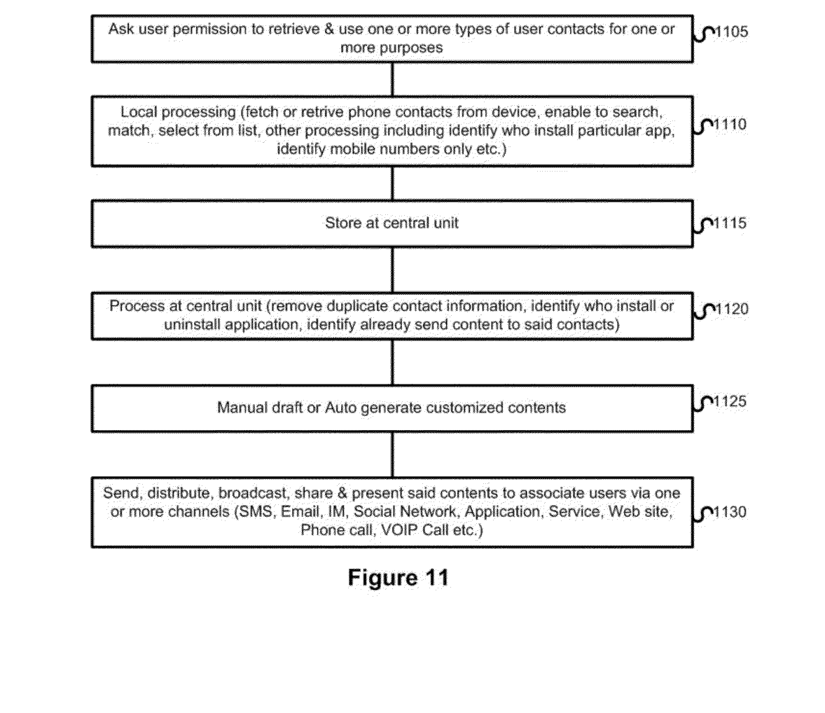

FIG. 11 explains flowchart describing different embodiment, flowchart shows that user is enable to provide permission to use or access user's one or more contacts for one or more types of purposes and asking of user permission to retrieve & use one or more types of user contacts for one or more purposes. In the event of user affirmation or confirmation to provide permission for using user's all or one or more contacts full or partial or selective information including phone number, email address & like for all or one or more selective purposes for particular duration and/or for particular times of sending one or more type of content(s) to user's contacts 1105, apply one or more process on said contact information including identify who already install application, remove landline number or other umber which are not mobile number & like 1110 and store after getting user permission, user selections and local processing at central unit or server 1115. After that process users contacts information at server including remove duplicate contacts from database, identify or create or update social graph including who is connected with whom, identify who install or uninstall application, identify that number of times content send to each contact & like 1120. After preparing list of contacts auto generate customize content 1125 for each contact for sending them said auto generated customized contents and then send, distribute, broadcast, share & present said contents to associate users via one or more channels (SMS, Email, IM, Social Network, Application, Service, Web site, Phone call, VOIP Call etc.) 1130

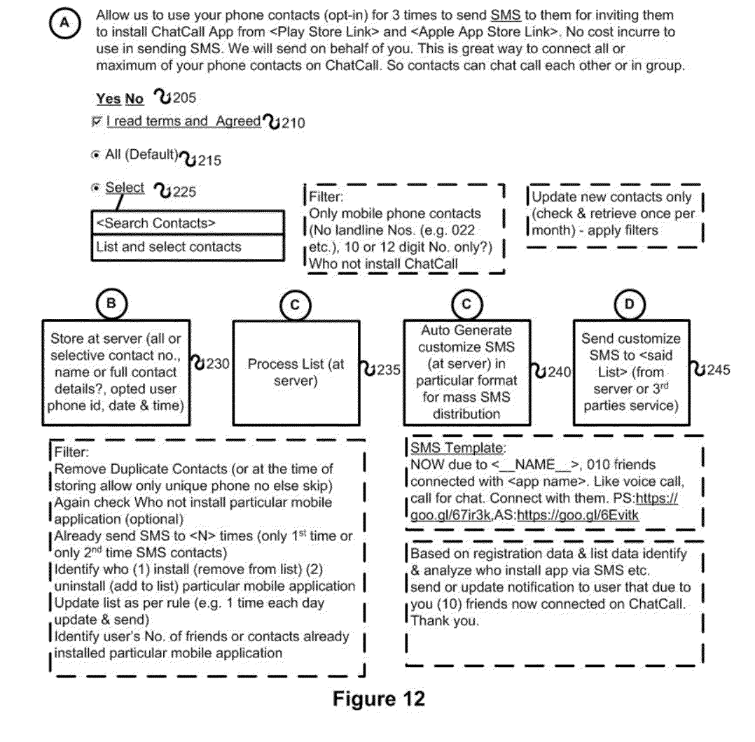

FIG. 12 illustrates one of the example of implementing inventive embodiment discuss in FIG. 11. In step 1 ask user permission 1205 to utilize user or user profile or user device contacts information to send SMS on behalf of user to one or more contacts for one or more times for one or more purposes including install mobile application from Google Play Store or Apple App store. After confirming permission show user agreements or terms & conditions 1210 for enabling user to read, print, consult & confirm or accept said user agreement and terms & conditions else close interface. After confirming or providing permission and accepting user agreement and terms & conditions, user is enabling to search, match, filter, group, rank, reorder & select all 1215 or one or more types of one or more contacts from list 1225. After selection of contacts, locally process or filter contacts including e.g. identify mobile phone numbers only, further filtration i.e. identify mobile phone numbers who not install particular mobile application and identify updated contacts. After locally or from local device selections, processing, formatting & filter of contacts, send or synchronize (push snapshot & merge replication) to central unit 1230 with metadata, system data, contact information, unique user identity including phone number & like. After storing said contact information at central unit from users of network, further process 1235 said aggregated contacts in central unit e.g. server including remove duplicate contacts (or at the time of storing allow only unique phone number else skip), again check who not install particular mobile application, identify already send SMS particular number of times, identify after sending of SMS who (1) install (remove from list) (2) uninstall (add to list) particular mobile application so accordingly update list for resending SMS to them for inviting them to install particular mobile application. Also process list after every particular period of time e.g. 24 hours or as per rule (e.g. one time each day update contacts & send SMS to them). Identify user's number of friends or contacts already installed particular mobile application for preparing customized SMS content targeting each contacts of prepared or updated list. After preparation of list of contacts and base on associate data, system data, metadata and parameters enable to manually draft or auto generate customize SMS content for each contact 1240 for sending them and send said auto generated customized content for each contact to each contact 1245. E.g. SMS Template: “NOW due to <max. 10 char source user's name>, <3 digit number e.g. 10> friends connected with <app name e.g. ChatCall>. Like voice call, call for chat. Connect with them. PS: https://goo.gl/67ir3k, AS: https://goo.gl/6Evitk”. So SMS content must within or up-to 160 chars. Base on registration data & list data identify & analyze who install app via SMS etc. and also send or update notification to source user (provider of contacts user) that due to you <source user name> <number e.g. (10)> friends or contacts now connected on <app name e.g. ChatCall>. Thank you.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

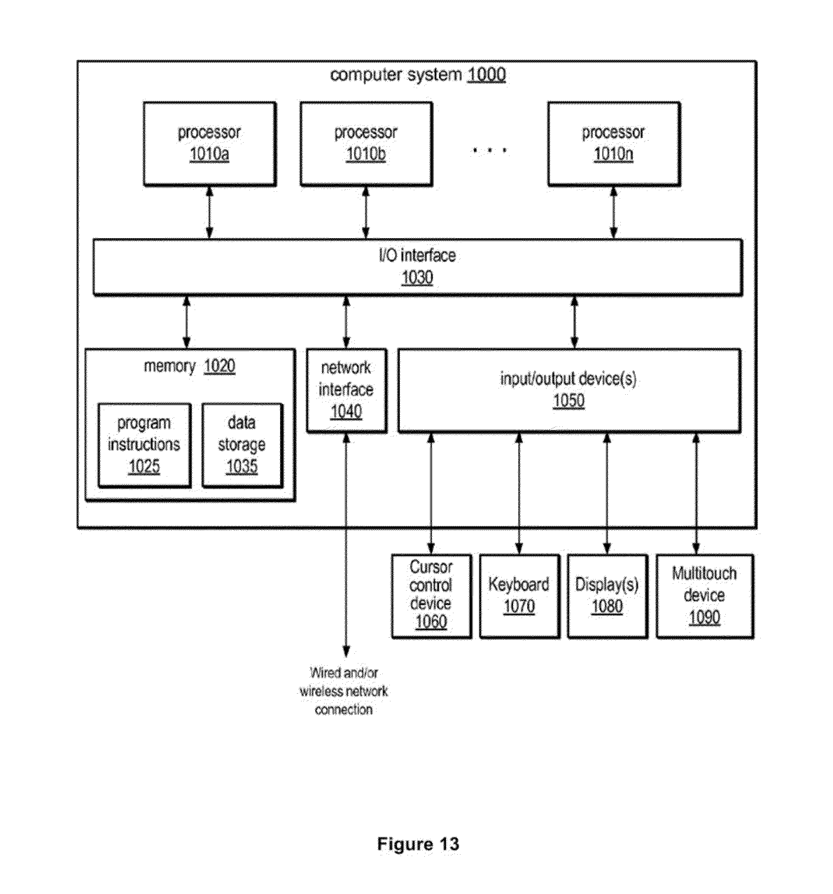

Various components of embodiments of methods as illustrated and described in the accompanying description may be executed on one or more computer systems, which may interact with various other devices. One such computer system is illustrated by FIG. 13. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

As shown in FIG. 13, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program). A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object oriented programming language(s).

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

What is claimed is:

1. A computer-implemented method for user to user posting and viewing of contents in a network environment, the method comprising:
providing at least one processor having computer-readable program code stored therein that, when executed by the at least one processor, causes the processor to perform the following method steps comprising:
a) serving by the server system, one or more content items posted by users of network at user interface;
b) monitoring by the server system, user interaction with served content items from user interface;
c) adding and storing points in memory by the server system, particular number of points to user account based on said user interaction with content items from interface;
d) receiving at a server system over a network, request to post one or more content items from user via user interface;
e) determining by the server system, available balance points enough to post said one or more content items;
f) in the event of determination of enough availability of points, receiving at a server system over a network, one or more posted content items from user via user interface;
g) monitoring by the server system, interaction of other users of network with said posted and presented one or more content items from respective user interface; and
h) deducting and storing in memory by the server system, particular number of points from user account based on said interaction of other users of network with said posted one or more content items from respective user interface.

2. The method of claim 1 wherein serving by the server system, one or more content items based on one or more rules and preferences including set number of target viewers, balance points and matching of content and one or more associated target criteria of posting user with user data of users of network, wherein posting target criteria comprise one or more keywords, categories, types, locations, places, age range, gender, entity names & types, interests, languages, include or exclude IP address, destinations & one or more type of criteria and user data comprise user profile, logged activities, actions, events, transactions, locations, places, status, preferences, privacy settings, search query, keywords, past views of contents.

3. The method of claim 1 wherein monitoring by the server system, user interaction with content items comprise monitoring and tracking of user's one or more activities, actions, events, transactions & statistics with content items including number of content items views, number of user actions on content items including like, dislike, report as spam or inappropriate, make comment or provide review, share, refer, order, book, buy, participate in group deal, provide user information & make call, duration of viewing or hearing or reading and number of times views of content items by user of network, wherein electronically storing a plurality of specified content interaction types including viewing photo, viewing video or live stream, reading text content, action types including like, dislike, make comment or provide review, share, refer, order, book, buy, participate in group deal, provide user information, make call and associated point values in a computerized database.

4. The method of claim 1 wherein calculating, by a computerized processor, an accumulated point value for the first user; and storing the accumulated point total value for the first user in a computerized data store, wherein adding a first point value to a first user based on a first interaction of a first specified type of a first content item, the first point value being based on the first interaction type and awarding a different point value not equal to the first point value to a second user and deduct point in the event of number of dislikes and report as spam or inappropriate content from users of network.

5. The method of claim 1 wherein enabling user to link and invite & link with one or more accounts of other users of network including contacts and add by the server system, collectively accumulated points to said linked account or deduct by the server system, points from said linked account.

6. The method of claim 1 wherein enabling by the server system, searching, matching, viewing, filtering, preference based subscribing, viewing suggested, viewing location specific, viewing auto presented contents, viewing auto presented contents based on user's one or more activities, actions, interactions, events, transactions, logged data, user data, profile data, locations, places, senses, behavior, status, date & time, subscriptions, user preferences & settings, device type, data network type and balance number of points, wherein content items comprise one or more advertisements, photo, video, voice, video stream, text, link, application, form, blog, contents presented from one or more sources, servers, devices, databases, networks, applications, and web sites.

7. The method of claim 1 wherein, dynamically change location or position of one or more controls including next button and previous button after one or more views for viewing next or previous available or presented content item and recording viewing video from user device for determining actual viewing of presented content items.

8. The method of claim 1 wherein, auto presenting next content item as per rules including auto present next photo content item with interval of particular period of time, auto present next video content item after finishing of video or length of duration of video, auto present next after set period of time, wherein period of time based on number of characters, keywords, phrases, lines, paragraph & pages.

9. The method of claim 1, wherein queuing and dynamically presenting said posted contents to user(s) or subscribed user(s) or searching user(s) or current active viewing users based on user preferences, subscription preferences, number of requests of views or auto presented content views, content purging policies, content removal policies, delivery policies, routing policies, security policies, batching policies, queuing criteria, rules, triggers, processes, scheduling policies, match making algorithms, total number of balance views of all posted contents of all users of network and total current contextual active viewing users or updated number of current viewers in network, date & time of posting, date & time of viewing users or current active users, duration of views, prioritize type, rank of viewing user and content, target criteria specific matched viewing users, time zone and location of viewers, number of pending viewers to server, categories and sub-categories queues based on rank and level of queue, one or more locations, places, keywords, profile data including age, gender, associate entity type & name, similar targeted contents, similar types of viewers, type or category of contents, rank of content, content associate metadata & keywords, model or basis, filters, sorts, activities, actions, attributes, interests, devices, destinations, senses, behavior, events, transactions and any combination thereof, wherein serve content based on first post first contextual viewers available basis, premium user basis, first post first show basis, more viewers more quick presentation basis and adjust points including increasing or decreasing points spending for per view based on demand and supply of one or more target criteria specific available viewers within particular period of time.

10. A computerized system for user to user posting and viewing of contents in a network environment, the system comprise:
providing at least one processor having computer-readable program code stored therein that, when executed by the at least one processor, causes the processor to perform the following system steps comprising:
a) the server system program code portion configured to serve one or more content items posted by users of network at user interface;
b) the server system program code portion configured to monitor user interaction with served content items from user interface;
c) the server system program code portion configured to add and store in memory particular number of points to user account based on said user interaction with content items from interface;
d) the server system program code portion configured to receive, request to post one or more content items from user via user interface;
e) the server system program code portion configured to determine, available balance points enough to post said one or more content items;
f) in the event of determination of enough availability of points, the server system program code portion configured to receive one or more posted content items from user via user interface;
g) the server system program code portion configured to monitor interaction of other users of network with said posted and presented one or more content items from respective user interface; and
h) the server system program code portion configured to deduct and store particular number of points from user account based on said interaction of other users of network with said posted one or more content items from respective user interface.

11. The system of claim 10 wherein served by the server system, one or more content items based on one or more rules and preferences including set number of target viewers, balance points and matching of content and one or more associated target criteria of posting user with user data of users of network, wherein posting target criteria comprise one or more keywords, categories, types, locations, places, age range, gender, entity names & types, interests, languages, include or exclude IP address, destinations & one or more type of criteria and user data comprise user profile, logged activities, actions, events, transactions, locations, places, status, preferences, privacy settings, search query, keywords, past views of contents.

12. The system of claim 10 wherein monitor by the server system, user interaction with content items comprise monitor and track user's one or more activities, actions, events, transactions & statistics with content items including number of content items views, number of user actions on content items including like, dislike, report as spam or inappropriate, make comment or provide review, share, refer, order, book, buy, participate in group deal, provide user information & make call, duration of viewing or hearing or reading and number of times views of content items by user of network, wherein electronically storing a plurality of specified content interaction types including viewing photo, viewing video or live stream, reading text content, action types including like, dislike, make comment or provide review, share, refer, order, book, buy, participate in group deal, provide user information, make call and associated point values in a computerized database.

13. The system of claim 10 wherein calculate, by a computerized processor, an accumulated point value for the first user; and store the accumulated point total value for the first user in a computerized data store, wherein add a first point value to a first user based on a first interaction of a first specified type of a first content item, the first point value being based on the first interaction type and awarding a different point value not equal to the first point value to a second user and deduct point in the event of number of dislikes and report as spam or inappropriate content from users of network.

14. The system of claim 10 wherein user is enable to link and invite & link with one or more accounts of other users of network including contacts and add by the server system, collectively accumulated points to said linked account or deduct by the server system, points from said linked account.

15. The system of claim 10 wherein user configured to search, match, view, filter, sort, preference based subscribe, view suggested, view location specific, view auto presented contents, view auto presented contents based on user's one or more activities, actions, interactions, events, transactions, logged data, user data, profile data, locations, places, senses, behavior, status, date & time, subscriptions, user preferences & settings, device type, data network type and balanced number of points, wherein content items comprise one or more advertisements, photo, video, voice, video stream, text, link, application, form, blog, contents presented from one or more sources, servers, devices, databases, networks, applications, and web sites.

16. The system of claim 10 wherein dynamically change location or position of one or more controls including next button and previous button after one or more views to view next or previous available or presented content item and record viewing video from user device for determining actual viewing of presented content items.

17. The system of claim 10 wherein auto present next content item as per rules including auto present next photo content item with interval of particular period of time, auto present next video content item after finishing of video or length of duration of video, auto present next after set period of time, wherein period of time based on number of characters, keywords, phrases, lines, paragraph & pages.

18. The system of claim 10 queuing and dynamically presenting said posted contents to user(s) or subscribed user(s) or searching user(s) or current active viewing users based on user preferences, subscription preferences, number of requests of views or auto presented content views, content purging policies, content removal policies, delivery policies, routing policies, security policies, batching policies, queuing criteria, rules, triggers, processes, scheduling policies, match making algorithms, total number of balance views of all posted contents of all users of network and total current contextual active viewing users or updated number of current viewers in network, date & time of posting, date & time of viewing users or current active users, duration of views, prioritize type, rank of viewing user and content, target criteria specific matched viewing users, time zone and location of viewers, number of pending viewers to server, categories and sub-categories queues based on rank and level of queue, one or more locations, places, keywords, profile data including age, gender, associate entity type & name, similar targeted contents, similar types of viewers, type or category of contents, rank of content, content associate metadata & keywords, model or basis, filters, sorts, activities, actions, attributes, interests, devices, destinations, senses, behavior, events, transactions and any combination thereof, wherein serve content based on first post first contextual viewers available basis, premium user basis, first post first show basis, more viewers more quick presentation basis and adjust points including increasing or decreasing points spending for per view based on demand and supply of one or more target criteria specific available viewers within particular period of time.

19. A computer-implemented method for user to user providing and requesting of one or more types of user services in a network environment, the method comprising:
providing at least one processor having computer-readable program code stored therein that, when executed by the at least one processor, causes the processor to perform the following method steps comprising:
a) enabling by the server system, conducting or participating in one or more requests or requirements specific one or more types of one or more activities, user actions, tasks, workflow, senses, events, transactions, communications, providing, publishing, viewing & sharing contents, collaboration, interactions and user services to requesting users of network via one or more interfaces, applications, web sites, objects, controls, web services, databases, networks, servers and devices;
b) monitoring by the server system, said one or more types of user interaction or contribution from/with/via one or more interfaces, applications, web sites, objects, controls, web services, databases, networks, servers and devices;
c) calculating, adding and storing points in memory by the server system, particular or determined number of points to respective user account based on said respective user interactions or contribution;
d) receiving at a server system over a network, request to conduct or participation or requirement of/for conducting one or more types of one or more activities, user actions, tasks, workflow, senses, events, transactions, communications, publishing, advertising, sharing, collaboration, interactions and one or more user services from users of network via user interface;
e) determining by the server system, available balance points enough to receive said one or more requests or requirement specifications;
f) in the event of determination of enough availability of points, receiving at a server system over a network, one or more requests or requirement specifications from user via user interface;
g) monitoring by the server system, said one or more requests or requirement specifications specific interaction, participation, providing and conduction of one or more types of one or more activities, user actions, tasks, workflow, senses, events, transactions, communications, publications, viewing advertisements, sharing content items, collaboration and one or more user services by other users of network from respective user interface; and
h) calculating, deducting and storing in memory by the server system, particular or determined number of points from respective user account based on said interaction of other users of network.

20. The method of claim 19, wherein enabling users of network to search, match, browse directory, subscribe preferences specific, view auto matched or auto presented and select requests or requirement specifications of other users of network for providing, participating and conducting of one or more said selected requests or requirement specifications specific one or more types of one or more activities, user actions, tasks, workflow, senses, events, transactions, communications, publications, viewing of advertisement, sharing content items, collaboration and providing of one or more user services via one or more interfaces, applications, web sites, objects, controls, web services, databases, networks, servers and devices.
